(19) United States
(12) Patent Application Publication
(10) Pub. No.: US 2015/0059228 A1
(43) Pub. Date: Mar. 5, 2015

(54) DECOY DEVICE

(71) Applicant: Daniel L. Holmes, Princeton, CA (US)

(72) Inventor: Daniel L. Holmes, Princeton, CA (US)

(21) Appl. No.: 14/013,002

(22) Filed: Aug. 28, 2013

(51) Int. Cl. A01M 31/06

(52) U.S. Cl. CPC A01M 31/06
USPC 43/3

(57) ABSTRACT

A decoy for use in game hunting can be enhanced with an attraction device. The attraction device may include a bracket that rotatably supports an s-shaped wing element. The wing element spins within the bracket to provide additional attraction to game, such as ducks. The attraction device may include a mounting flange for mounting to a decoy, such as a duck decoy, through the use of shock cords or the like.

### CROSS REFERENCE TO RELATED APPLICATIONS

This application claims priority to U.S. provisional patent application Ser. No. 61/695,251, filed Aug. 30, 2012 the contents of which is herein incorporated by reference.

### FIELD OF THE INVENTION

The present invention relates to hunting devices and in particular to decoy devices.

### BACKGROUND

In the field of game hunting, hunting decoys are devices that mimic the game and are intended to attract the game towards it. It has been found that flying ducks are drawn to decoys that have a spinning, flashing element attached to their backs.

### SUMMARY OF ONE EMBODIMENT OF THE INVENTION

### ADVANTAGES OF ONE OR MORE EMBODIMENTS OF THE PRESENT INVENTION

The various embodiments of the present invention may, but do not necessarily, achieve one or more of the following advantages:

the ability to provide a wind driven attraction device; and

provide a flashing device that is more attractive ducks and other game birdlife;

provide a device that causes a ripple on the water;

provide an attraction device that can be removable attached to a decoy; and

provide an attraction device that can be attached to a large number of available decoys.

These and other advantages may be realized by reference to the remaining portions of the specification, claims, and abstract.

### BRIEF DESCRIPTION OF ONE EMBODIMENT OF THE PRESENT INVENTION

In one aspect, the invention provides an attraction device for attachment to a decoy used in game hunting. The attraction device may comprise a bracket that supports a wing element. The wing element may be rotatably mounted onto the bracket such that the wing element can spin freely within the bracket.

In one aspect, the invention provides a method for providing an enhanced decoy. The method may include mounting an attraction device to a decoy. The attraction device may comprises a bracket that rotatably supports a wing element and a mounting arrangement for mounting the attraction device to the decoy.

In one aspect, the invention provides an attraction device comprising wing means and bracket means. The wing means may be for rotating to provide an attraction element and the bracket means may be for rotatably supporting the wing means.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a perspective view of an attraction device;

FIG. 2 is substantially a front view of the attraction device of FIG. 1;

FIG. 3 is substantially a side view of the attraction device;

FIG. 4 is substantially a side view of a wing element;

FIG. 5 is substantially a front view of the wing element of FIG. 4;

FIG. 6 is substantially a perspective view of a support shaft;

FIG. 7 is substantially a perspective of the mounting of the wing within one end of the bracket;

FIG. 8 is substantially an illustration of the attachment of the attraction device to a decoy;

FIG. 9 is substantially a perspective view of a fan bracket in position to be attached to an attraction device of the present invention.

FIG. 10 is substantially a perspective view of a fan bracket attached to the attraction device of the present invention.

FIG. 11 is substantially a perspective view of a fan in position to be inserted into a fan bracket of the present invention.

FIG. 12 is substantially a perspective view of a fan attached to an attraction device of the presenting invention by a fan bracket.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

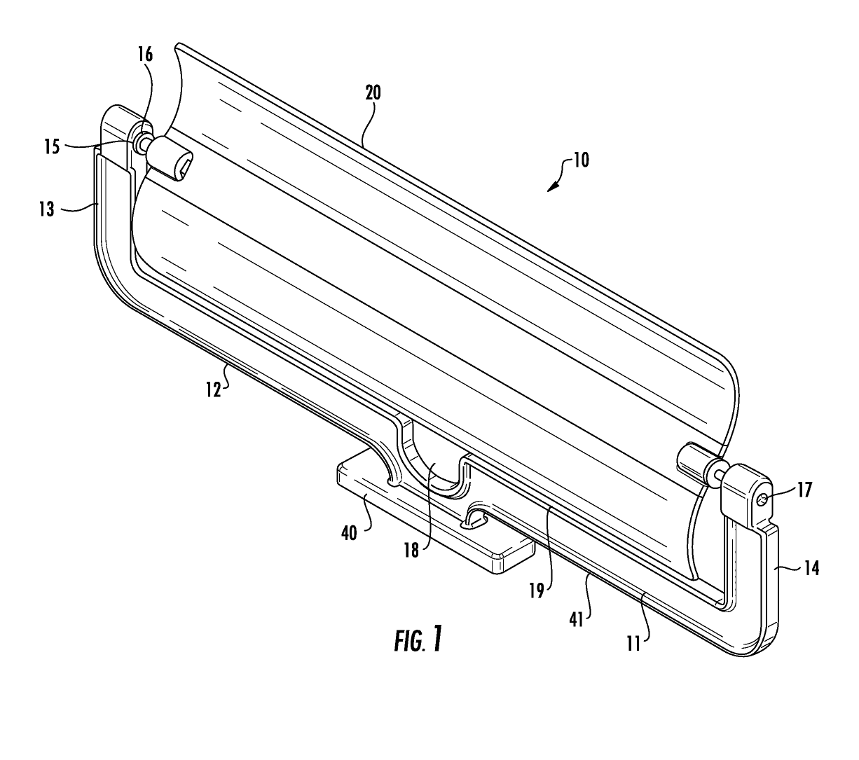

In FIG. 1, there is shown an attraction device 10 that can be attached to decoys to provide greater attraction to ducks and similar game. The attraction device 10 includes a substantially u-shaped bracket 11 having a base member 12, first side member 13 and second side member 14. Rotationally supported by the bracket 11 is a wing element 20.

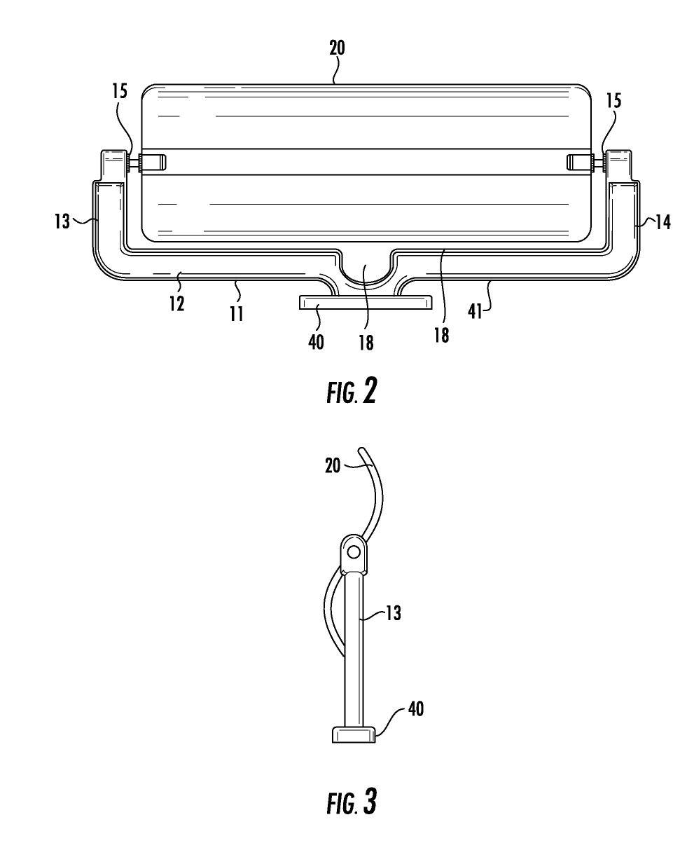

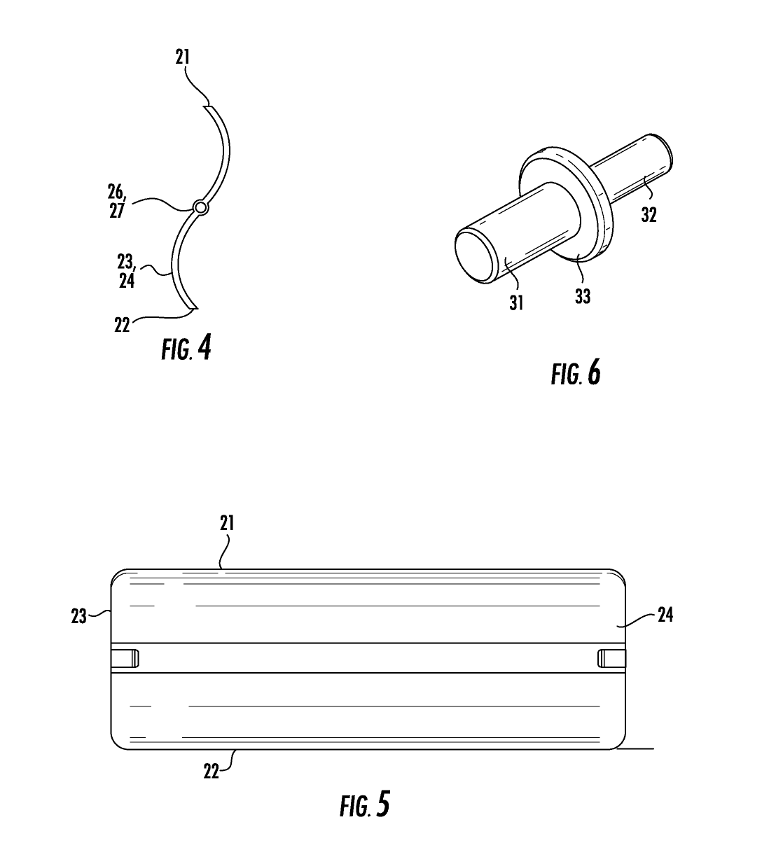

With reference to FIGS. 1 to 5, and in particular FIGS. 4 and 5, the wing element 20 is a relatively thin component having straight upper 21 and lower 22 edges. Side edges 23, 24 are curved to have a substantially s-shaped profile, as seen most clearly in the side view of FIGS. 3 and 4. This profile is designed to catch the wind in order to cause the wing element to rotate. Other profiles that achieve this aim will be apparent to the person skilled in the art. For example, the wing element may be a flat rectangular element.

In another embodiment, wing element 20 is twisted along its longitudinal axis so that upper and lower edges 21 and 22, respectively, form a double helix shape. The angle of twist from side edge 23 to side edge 24 may be different amounts. In one embodiment, the angle of twist is 23 degrees. One of the advantages of this embodiment is that the helical surface of wing element 20 always presents a surface that catches wind. In the case of the non-twisted embodiment, when the lateral axis is in a horizontal position, very little surface area is presented perpendicular to horizontally flowing wind. This may prevent wing element from moving in light winds.

Each of the side edges 23, 24 includes an aperture 26, 27 at approximately the centre of the side edge that extends inwards of the side edge. The apertures 26, 27 are sized to receive a shaft of a support bearing as will be described in more detail below. Nominal dimensions for the wing element 20 are illustrated in FIGS. 4 and 5, however such dimensions are provided by way of example only and are not intended to be limiting in any manner. The wing 20 may be a molded plastic, pressed metal, or other suitable material.

The side members 13, 14 of the bracket 11 each have apertures 16, 17 at a height that is able to align with the apertures 26, 27 of the wing element 20. A cylindrical bearing 15 may be press fit into each of the apertures 16, 17. The bearing 15 has central aperture (not shown) that receives a support shaft as will be described below. Alternatively, bearings 15 may be press fit into apertures in wing element 20.

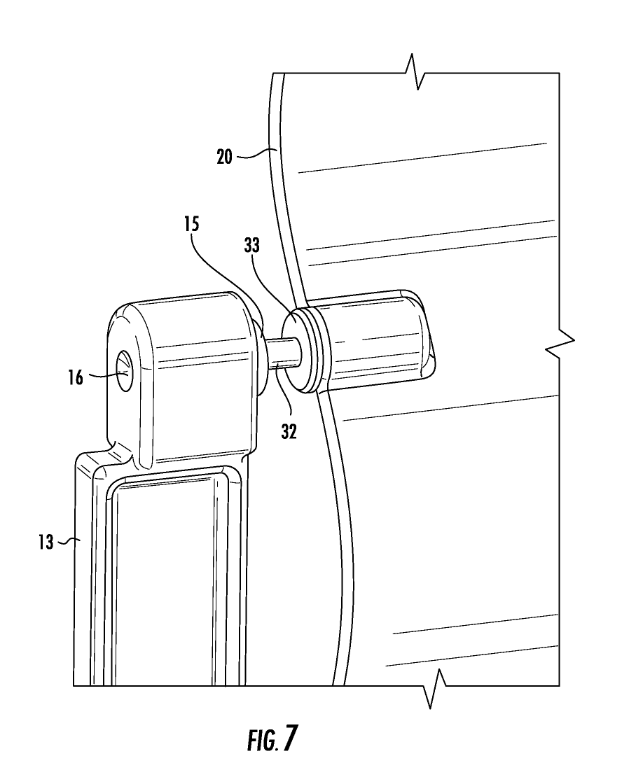

A support shaft 30 is used to support the wing 20 within the bracket 11. The support shaft 30, shown in FIG. 6, includes a first cylindrical shaft 31 and a second cylindrical shaft 32 separated by a central flange 33. The first shaft 31 may be of a different diameter and/or a different length to the second shaft or these dimensions may be equal, allowing the support shaft 30 to be reversible. In one embodiment, the support shaft 30 is made of stainless steel, though other suitable materials, including plastics, metals, etc, will be apparent to the person skilled in the art.

The first shaft 31 of support shaft 30 is press fit into respective apertures 26, 27 of the wing. The press fit provides tight engagement between the support shaft 30 and the wing 20 so that the support shafts 30 do not spin freely within the wing 20.

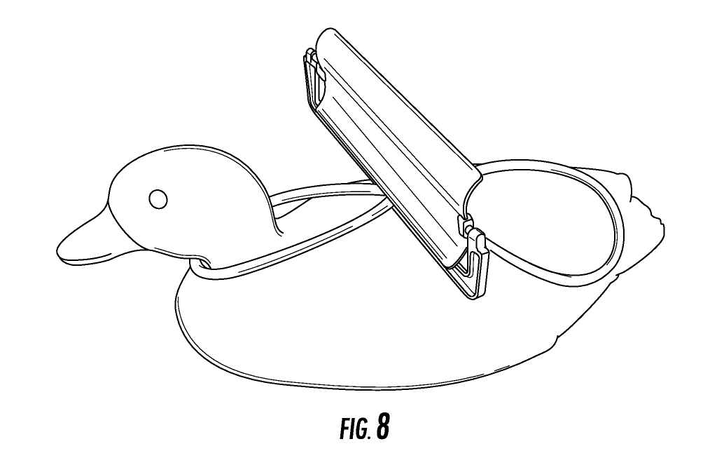

The bracket 11 may be a plastic, metal, or any other suitable material. In one embodiment, the bracket 11 is a molded plastic. The base member 12 of the bracket 11 may be provided with a notch 18 on the inner edge 19. The notch 18 provides a thinning of the bracket 11 that allows the side members 13, 14 to be flexed outwardly to increase the distance between the apertures 16, 17. To mount the wing 20 to the bracket 11 (FIG. 7), a second shaft 32 of the first support shaft 30 may be received into the bearing 15 within the aperture 16 of first side member 13. The side arms may then be flexed outwardly so that the second shaft 32 of the second support shaft 30 can be received into the bearing 15 within the aperture 17 of the second side member 14, thereby accommodating the wing 20 into the gap between the side members 16, 17.

The second shafts 32 of the support shafts 30 are received into the bearings 15 and are able to spin freely. The wing 20 is thus able to rotate within the bracket 11 about the axis of the support shafts 30.

The attraction device 10 may be mounted to a decoy in any suitable manner. In one embodiment, a mounting flange 40 is provided on the base member 12 on an outer edge 41 opposite the inner edge 19. The mounting flange 40 is depicted as a rectangular flange though other configurations and locations of the mounting flange 40 will be apparent to the person skilled in the art. The attraction device 10 may be secured to a decoy using a suitable tying device such as a cord, rope, string, etc. In one embodiment, an elastic cord 42 may be secured about the mounting flange 40 and the decoy, as shown in FIG. 8, to secure the attraction device to the decoy. Elastic cord 42 may form a FIG. 8 with one loop going around the decoy's neck and the other loop going around the decoy's tail. The junction of the loops may be placed in notch 18 so that flange 40 is held against the back of the decoy. Other attachment mechanisms will be apparent to persons skilled in the art.

In use, with the attraction device attached to an otherwise static decoy, the wind will drive the wing member 20 causing it to rotate. The wind will create realistic movement in the decoy and add motion making them look more like live ducks sending water rings simulating wing beats.

The wing 20 and/or bracket 11 may be painted with a ultra violet (UV) reflective paint to better simulate feathers from live ducks, making the device 10 more visible to birds and protecting the device from fading due to UV rays. The UV paint may only be applied to one side of wing element 20, which provides for a flashing effect. It has been found that flashing reflected UV light better attracts birds. In an alternative embodiment, a UV reflective substance is incorporated in wing element 20 rather than being applied to its surface. If wing element 20 is injection molded, for example, the UV reflective substance may be incorporated in plastic that is injected into one side of a mold. This provides reflectance on one side of wing element 20.

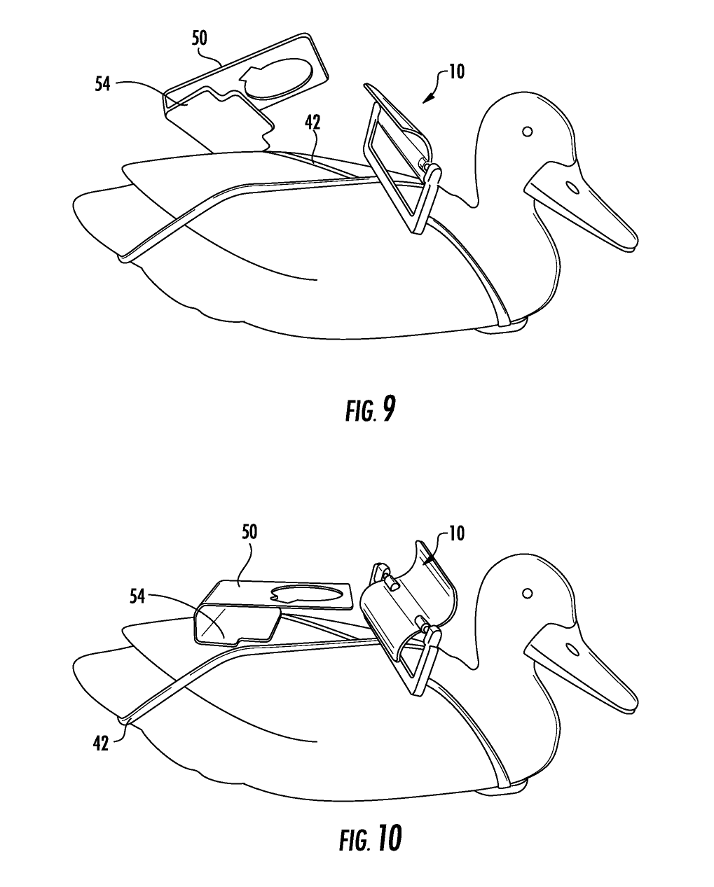

Turning to FIGS. 9 through 12, a fan bracket 50 is shown for attaching a fan to attraction device 10. As seen in FIG. 9, bracket 50 is positioned to be attached to elastic cord 42. A keyhole or channel 54 may be provided in an edge of bracket 50 for receiving elastic cord 42. As seen in FIG. 10, both sides of bracket 50 may be attached to elastic cord 42 by engaging strands of elastic cord 42.

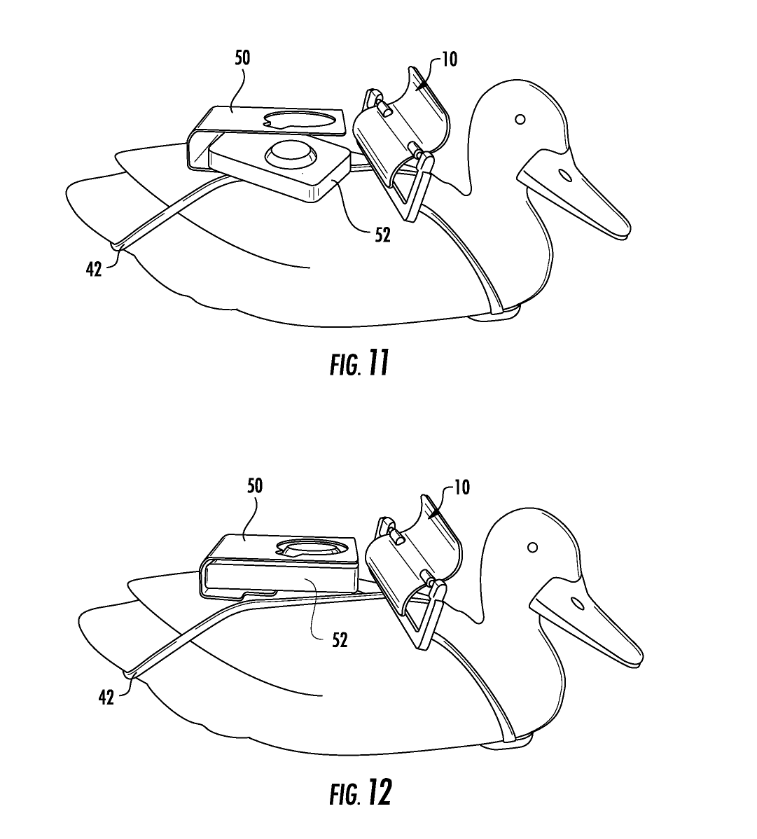

As seen in FIG. 11, a fan 52 is positioned to be inserted into fan bracket 50. Fan 52 may be battery or solar powered and it may be designed to resist water intrusion. In one embodiment, fan 52 is provided with an antenna, radio receiver and relay to allow the fan to be operated remotely. As seen in FIG. 12, fan 52 is inserted into bracket 50. Bracket 50 holds fan 52 so that it directs a stream of moving air onto attraction device 10. This allows attraction device 10 to be used when there is no naturally occurring breeze. Bracket 50 may hold fan 52 by way of friction, snaps, screws, elastic bands or other attachment mechanisms.

Reference to terms of orientation such as upper, lower, side, etc. refer to the depictions shown in the accompanying figures and are used for the sake of clarity. These terms are not used to refer to any required orientation of the apparatus when used and should not be considered limiting in any way.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. An attraction device for attachment to a decoy used in game hunting, the attraction device comprising:
(A) a bracket;
(B) at least one wing element; and
(C) wherein the at least one wing element is rotatably supported by the bracket such that the at least one wing element can spin within the bracket.

2. The attraction device of claim 1 wherein the bracket comprises:
(A) a bottom member having a first end and a second end;
(B) a first side member extending from the first end and a second side member extending from the second end; and
(C) wherein the at least one wing element is supported between the first side member and the second side member.

3. The attraction device of claim 2 wherein the first side member and the second side member each comprise an aperture that receives a bearing for rotatably supporting the at least one wing element.

4. The attraction device of claim 1 wherein the bracket is substantially u-shaped.

5. The attraction device of claim 1 wherein the at least one wing element comprises a first side edge and a second side edge, wherein the at least one wing element is supported in the bracket by the first side edge and the second side edge.

6. The attraction device of claim 5 wherein the first side edge and the second side edge have a substantially s-shaped profile.

7. The attraction device of claim 5 wherein the first side edge and the second side edge each comprise an aperture that receives a support shaft for rotatably mounting the at least one wing element to the bracket.

8. The attraction device of claim 1 wherein the bracket comprises a mounting flange for facilitating mounting of the attraction device to a decoy.

9. The attraction device of claim 1 wherein at least one surface of the wing element comprises an ultra-violet reflective coating.

10. A method for providing an enhanced decoy comprising:
(A) providing a decoy; and
(B) providing an attraction device comprising:
(a) a bracket; and
(b) at least one wing element rotatably supported by the bracket such that the at least one wing element can spin within the bracket; and
(C) mounting the attraction device to the decoy.

11. The method of claim 10 wherein the attraction device comprises a mounting flange, wherein mounting the attraction device to the decoy comprises utilizing the mounting flange.

12. The method of claim 11 wherein mounting the attraction device comprises securing at least one tying device about the decoy and the mounting flange.

13. An attraction device comprising:
(A) wing means for rotating to provide an attraction element; and
(B) bracket means for rotatably supporting the wing means.

14. The attraction device of claim 13 wherein the bracket means is substantially u-shaped.

15. The attraction device of claim 13 wherein the wing means has a substantially s-shaped profile.

16. The attraction device of claim 13 comprising mounting means for mounting the attraction device to a decoy.
